(19) United States
(12) Patent Application Publication
(10) Pub. No.: US 2003/0030791 A1
(43) Pub. Date: Feb. 13, 2003

(54) Portable wheel alignment system

(76) Inventor: Pat O'Harra, Boise, ID (US)

Correspondence Address: PEDERSEN & COMPANY, PLLC, P.O. BOX 2666, BOISE, ID, 83701, US

(21) Appl. No.: 09/955,578

(22) Filed: Sep. 17, 2001

Related U.S. Application Data
(60) Provisional application No. 60/232,751, filed on Sep. 15, 2000.

(51) Int. Cl. G01C 1/00

(52) U.S. Cl. 356/139.09

(57) ABSTRACT

The present invention discloses a method and apparatus for accurately measuring vehicle wheel alignment parameters in various environments. This invention relates generally to vehicle wheel alignment. More specifically, this invention relates to portable, radio-frequency or hard wired alignment systems for providing alignment services at disparate field locations including the vehicle owners' garage or yard. The novel invention allows the user to transport the alignment measuring system to the vehicle to be serviced, thus allowing the vehicle owner avoid the added expense and inconvenience of transporting the vehicle to an alignment service area. The method of the present invention is accomplished by utilizing optical alignment sensors and on-site leveling techniques employing shims, leveling plates and an inclinometer, which allow the user to obtain accurate alignment measurements in the field. The instant invention discloses a novel portable method and apparatus for providing accurate alignment services in the field.

### DESCRIPTION

This application claims priority of my prior, co-pending provisional patent application Serial No. 60/232,751, filed on Sep. 15, 2000, entitled “Portable Wheel Alignment System,” which is incorporated herein by reference.

### BACKGROUND OF THE INVENTION

1. Field of the Invention

This invention relates generally to vehicle wheel alignment. More specifically, this invention relates to portable, radio-frequency or hard wired alignment systems for providing alignment services at disparate field locations including the vehicle owners' garage or yard. The instant invention discloses a novel portable method and apparatus for providing accurate alignment services in the field.

2. Related Art

Various systems have been designed to determine vehicle wheel alignment parameters such as caster, camber, front and rear wheel toe, scrub angle, and thrust angle. For example, U.S. Pat. No. 4,034,479 describes an instrument for measuring angles between relatively movable references, and for use in determining vehicle wheel alignment characteristics. The '479 patent utilizes alignment monitoring instruments mounted on the wheel rims, each such monitoring instrument being rigidly attached to alignment monitoring transducer boxes which are, in turn, coupled together by an elastic cord. The combination of instruments creates a frame for measuring various wheel alignment parameters.

U.S. Pat. No. 5,870,315 describes a method and apparatus for determining vehicle wheel alignment parameters using optical targets mounted on the wheels and optical targets mounted in a fixed relationship with respect to the surface on which the wheels are disposed. Video cameras are used to obtain images of the various optical targets and a computer is used to determine the values of wheel alignment parameters.

There exist numerous systems for measuring vehicle wheel alignment parameters similar to those described in the above referenced patents. Most alignment measuring systems, however, are designed to be used in a controlled environment such as a repair shops with flat, level floors and/or vehicle pit racks, lift racks and the like.

U.S. Pat. No. 5,815,257 describes a method and apparatus for determining vehicle wheel alignment parameters which is portable. The '257 patent, however, is for use with race cars and other high performance road vehicles. The '257 patent discloses a non-electrical alignment apparatus intended to be used in race car pit areas. The '257 patent does not utilize computer control or analysis in calculating alignment parameters.

### SUMMARY OF THE INVENTION

This invention relates to portable alignment systems for providing alignment services at disparate field locations including, for instance, the vehicle owners' garage or yard. Among the various objects and features of the present invention is the substantial advantage of complete portability. It is an object of the current invention to overcome the disadvantages of the prior art by providing a vehicle wheel alignment system which is able to be transported to and utilized at disparate field sites for the benefit of vehicle owners. The instant invention enables the user to accurately measure vehicle wheel alignment parameters in environments such as owner garages, yards and loading docks.

Heretofore, it has been necessary to perform alignment services in controlled environments such as a maintenance shop. Prior to the instant invention, it has been necessary to measure vehicle wheel alignment parameters in an environment where it was assumed that the subject vehicle was positioned on a level surface, such as a flat shop floor, vehicle pit rack or vehicle lift rack. While many sophisticated, accurate vehicle wheel alignment systems exist, they are designed with the built in assumption that the measurements will be taken with the vehicle on a level surface.

It is an object of the present invention to provide an alignment system which enables the user to perform accurate vehicle wheel alignment parameter measurements in a variety of environments, such as truck yards and loading docks, where the surface may not be level. It is a further object of the present invention to provide an alignment system which enables the user to perform accurate vehicle wheel alignment parameter measurements while the subject vehicle is on loose or unstable surfaces, such as hot pavement, dirt or gravel.

The present invention also has the substantial advantage of being entirely portable. The invention's portability, combined with its capacity to give accurate vehicle wheel alignment parameter measurements in diverse environments, enables the user to employ the instant invention in a variety of settings. It is a further object of the present invention to overcome the substantial deficiencies of the prior art by enabling users to make alignment measurements on-site. Said combination of portability and flexibility allows, for the first time, vehicle owners to have alignment services performed without having to transport the vehicle to a remote maintenance shop. Heavy duty truck owners, for example, have a strong interest in keeping their vehicles' down time to a minimum. The present invention allows the user to perform alignment services at the owner's yard or garage while other maintenance activities are being performed. The invention has the added benefit that no alignment strings or cords are used, thus allowing other maintenance personnel to perform their duties free from obstruction. The present invention effectively eliminates alignment service related downtime, allowing vehicle owners to have alignment services performed without taking the vehicle out of service.

It is a further object of the present invention to provide a vehicle alignment system which is capable of accurately measuring vehicle wheel alignment parameters in outdoor conditions. Not only does the instant invention allow the user to perform accurate vehicle wheel alignment parameter measurements while the subject vehicle is on loose or unstable surfaces, such as hot pavement, dirt or gravel, but also the invention is unaffected by wind or rain. Prior alignment systems which utilize strings or cords for making measurements cannot be used in windy or rainy environments due to the wind and rain disturbing the string or cord. Furthermore, strings or cords are inconvenient in environments where the subject vehicle is undergoing other maintenance as maintenance personnel are blocked from access to the vehicle by said strings and/or cords. The present invention overcomes these disadvantages of the prior art.

It is a further object of the present invention to provide a portable, flexible vehicle alignment system which is simple and easily used. The present invention gives accurate vehicle alignment information through directly readable indicators such as computer monitors and/or printed readouts. Said information allows the user to make immediate adjustments as necessary.

The apparatus of the present invention includes a system for use in checking or determining vehicle wheel alignment of the front and rear wheels. The system includes a computer and monitor for analyzing and displaying alignment parameters, respectively. Vehicle manufacturer alignment data is loaded onto the computer and used for assessing compliance with manufacturer alignment specifications. The system also includes electronic sensors which attach to the wheels of the subject vehicle. Preferably, the sensors use optical infrared emitters and detectors to generate vehicle wheel alignment data. The data is preferably transmitted to the computer via high frequency, spread spectrum transmitters. The apparatus also includes an inclinometer for measuring caster. In order to provide a level alignment parameter measuring environment, there is also included a laser leveler and leveling plates. The leveling plates are used to support conventional turn plates. Shims of various thickness are used to bring the turn plates into level as determined by the laser leveler. The invention includes a plurality of shims allowing the user to bring the turn plates into level in a variety of circumstances. The turn plates receive the front wheels of the vehicle being aligned.

The invention resides in a method for performing accurate vehicle wheel alignment parameter measurements in field environments. The method comprises driving the front wheels of the subject vehicle onto the turn plates which are resting upon the leveling plates. The laser leveler is used to determine the relative level of the turn plates. If the turn plates are not level, the vehicle is raised off the turn plates, shims of the thickness necessary to bring the turn plates into level are inserted, and the vehicle is lowered back onto the turn plates. Once it is determined that the front wheels of the vehicle is level, axle pitch and frame pitch are is measured using the inclinometer. Also, the caster information is downloaded to the computer for subsequent alignment parameter calculations. The electronic sensors are then placed on the vehicle wheels, the sensors are zeroed-out, or compensated one at a time, accounting for axle pitch and frame pitch. Then, the alignment measurements are taken. The alignment information from the sensors is transmitted to the computer and alignment corrections are calculated by the computer. Adjustments are made as necessary according to convention to bring the vehicle into alignment according to vehicle manufacturer specifications.

### BRIEF DESCRIPTION OF THE DRAWINGS

FIG. 1 is a top, schematic view of a vehicle wherein electronic sensors are attached to front and rear axle wheels; a console for housing electronic components and alignment displays; and a leveling device.

FIGS. 2A and 2B are front, schematic views of the front wheels of a vehicle both before and after leveling.

FIG. 3 is a perspective view of the vehicle in FIG. 1 wherein an inclinometer has been placed on the frame of the vehicle, and a side schematic view of a leveling plate.

### DETAILED DESCRIPTION OF THE INVENTION

The present invention utilizes known alignment measurement instruments and incorporates said instruments into a portable system. The novel system allows the user to transport the known alignment system to disparate field locations and to make accurate alignment measurements in non-controlled environments. The instruments are bolted into a transport vehicle, for instance the instruments may be bolted into the cab of a pickup truck which has had the rear seat removed. Sensitive electronic sensors are mounted onto the back of the cab with mounting brackets in order to diminish vibration during transport. The entire unit is rechargeable.

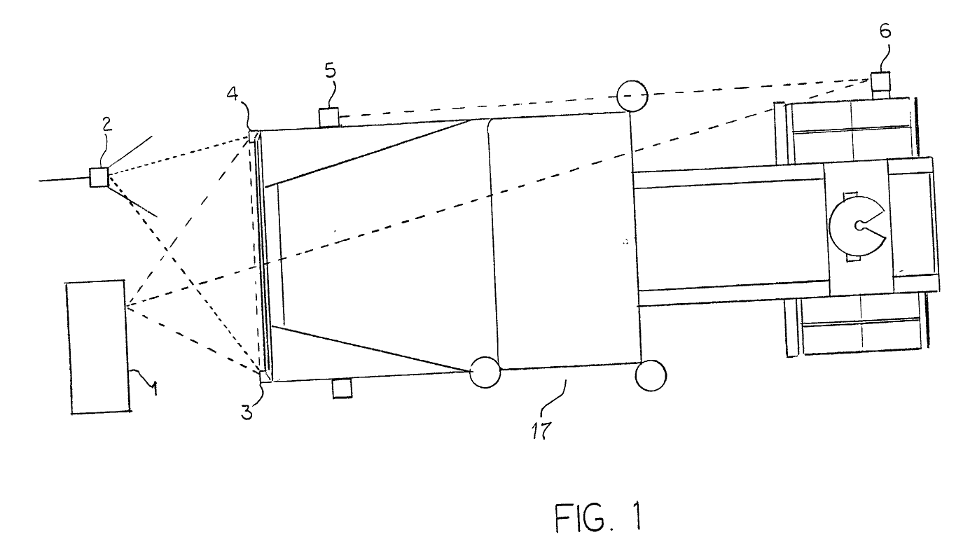

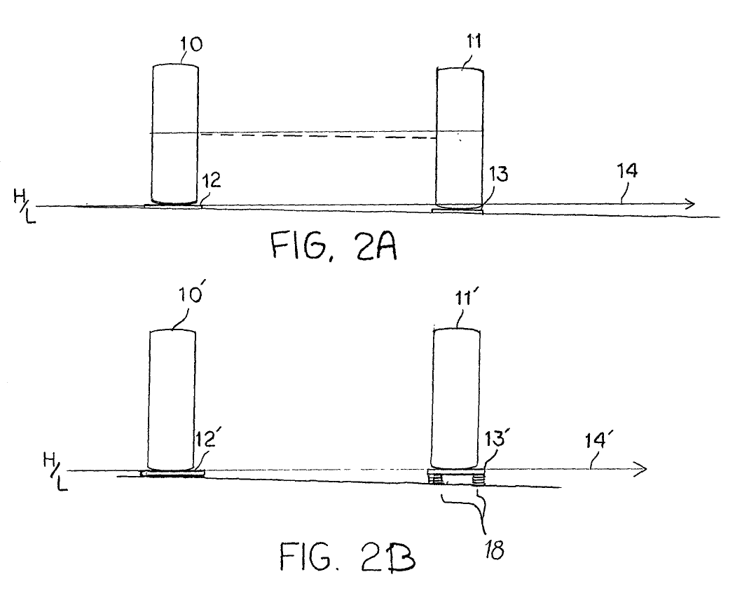

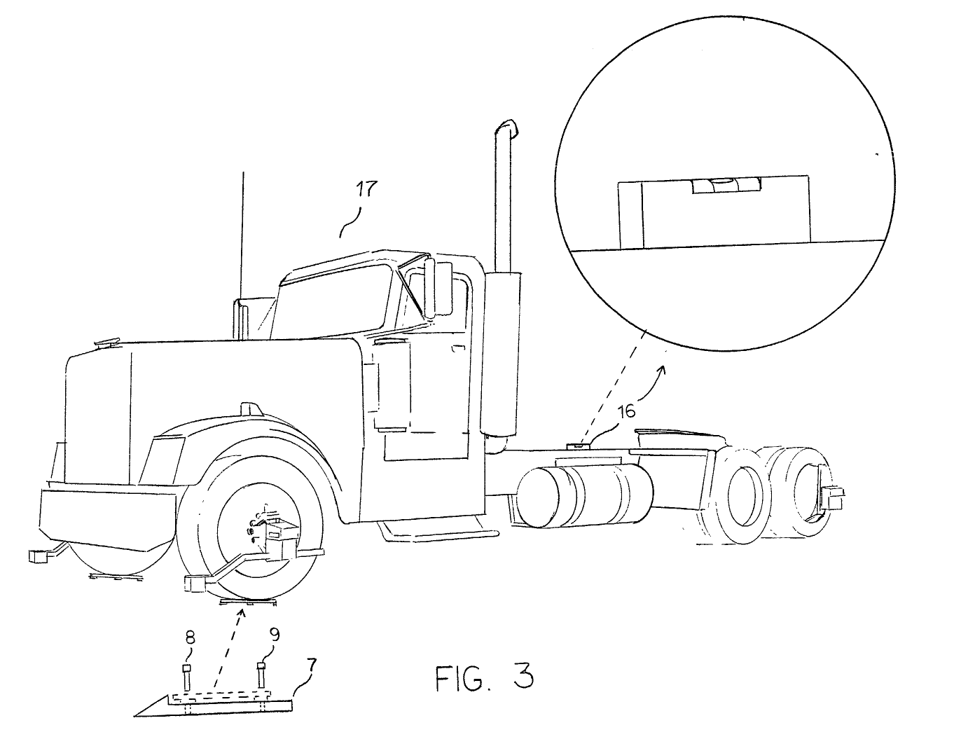

A presently preferred arrangement of the novel apparatus is shown in FIG. 1, and the associated leveling devices are shown in more detail in FIGS. 2 and 3. In FIG. 1, the front wheels and one set of rear wheels of the subject vehicle 17 are equipped with sensor means 3, 4, 5, and 6. Each sensor is capable of communicating optically with other sensors. In a preferred embodiment, sensors 3, 4, 5, and 6 are optical infrared emitters and detectors capable of projecting and receiving radiant energy beams transversely, relative to the centerline of the vehicle, as shown by the broken line running between sensors 3 and 4. Sensors 3, 4, 5, and 6 are also capable of projecting radiant energy beams longitudinally, relative to the centerline of the vehicle, as shown by the broken line running between sensors 5 and 6. FIG. 1 also shows a console 1 for housing electronic equipment including: a computer for analyzing alignment data received from the sensors 3, 4, 5, and 6; a receiver for receiving data transmitted from sensors 3, 4, 5, and 6; an alignment display for displaying alignment information to the user, and; other electronic devices as necessary. A leveling device 2 is shown adjacent to the console 1. The leveling device 2 is preferably a laser leveler used to ensure that the base of the front wheels of the vehicle 17 are level with each other, as shown in FIG. 2, in the horizontal plane 14′ tangent to the base of each front wheel 10′ and 11′.

FIG. 2 shows a front schematic view of the front wheels 10 and 11 of the subject vehicle 17. The wheels are shown before leveling as 10 and 11, and again after leveling as 10′ and 11′. Turn plates 12 and 13 are shown before leveling and after leveling as 12′ and 13′. The desired level horizontal plane is shown as line 14 and again after leveling as 14′. Turn plate 13′ is shown after leveling as being supported by shims 18 of the particular thickness necessary for leveling.

The shims 18, or some other portable leveling means, are essential to the present invention. The shims 18 of the present invention preferably consist of super-hardened stainless steel. The shims 18 may be in the form of washers ranging from a thickness of ⅛ inch or less to 1 inch or more. Preferably, washer type shims 18 are placed below each of the four corners of the base of the turn plates 12 and 13. The shims 18 may also be in the form of rectangular bars and similarly placed under the base of the outside edges of the turn plates 12 and 13.

FIG. 3 is a perspective view of the subject vehicle 17. An inclinometer 16 is shown on the frame of the subject vehicle 17. FIG. 3 also shows a side schematic view of a leveling plate 7. The leveling plate 7 utilizes stakes 8 and 9 used to secure the leveling plate 7 in place. Leveling plates are preferably used in instances where the surface upon which the subject vehicle rests is unstable. For instance, leveling plates are preferably used when the vehicle is located in a yard wherein the surface is gravel, soft dirt or hot asphalt. Shims 18 may be placed below each of the four corners of the leveling plate 7.

The apparatus of the instant invention is used to measure alignment parameters which are well known to those skilled in the art. However, the present invention allows the user to make accurate alignment measurements outside of the repair shop in a variety of field conditions and subject to varying environmental conditions. The alignment parameters measured include thrust angle, caster, camber, toe relative to the chassis, scrub angle, and other alignment parameters of the vehicle wheels per their conventional and accepted industry definitions. For example, caster is defined as the inclination of the kingpin or its equivalent in vehicle steering, which is positive if the kingpin inclines forward, negative if it inclines backward, and zero if it is vertical as viewed along the axis of the front wheels. Camber is defined as the inclination from vertical of the steerable wheels of a vehicle. Toe is defined as the angle between the rolling direction of a specified wheel and the centerline of the vehicle. Thrust angle is defined to be the angle between the thrust line and the centerline. The thrust angle is defined to be positive when the thrust line points to the right (as viewed from the front of the vehicle) relative to the centerline.

All alignment measuring device requires that the equipment to be used in the alignment procedure be calibrated to ensure compliance to operation within the design parameters of the device. In order to achieve accurate readings, the alignment measuring device should be calibrated often. It is also necessary to zero the device once all instruments are in place and before taking measurements.

Proper use of any alignment system requires that the subject vehicle rest on a flat surface. Heretofore, this has been accomplished by performing alignment services in a controlled environment such as a repair shop where the floor is known to be flat and level, or with the aid of a pit or lift rack which can be adjusted to provide such a surface. The method and apparatus of the present invention allows the user to perform accurate vehicle wheel alignment measurements in less controlled environments, such as the subject vehicle owner's garage, yard or loading dock.

The preferred method for carrying out the present invention comprises the following steps: The subject vehicle 17 is driven onto the turn plates 12 and 13. The leveling device 2 is used to determine the level of the turn plates 12 and 13 relative to horizontal plane 14. If turn plates 12 and 13 are not level, the subject vehicle 17 is raised above the turn plates 12 and 13. Shims 18 of sufficient width are placed beneath the lower of the turn plates 12 and 13 such that the upper surface of each plate comes to reside in horizontal plane 14′. The leveling device 2 is used again to confirm that turn plates 12 and 13 are level. Inclinometer 16 is placed on the frame of the subject vehicle 17 to determine axle pitch and frame pitch. Caster information is downloaded to a computer located in the console 1. Axle pitch and frame pitch information is taken into account by the computer, zeroing out, or compensating, the sensors when calculating alignment parameters. The electronic sensors 3, 4, 5, and 6 are attached to the vehicle 17 wheels, and alignment data is gathered in the normal fashion. The electronic sensors 3, 4, 5, and 6 communicate optically with each other in order to generate all necessary alignment data in the conventional manner. In the preferred embodiment, sensors 3, 4, 5, and 6 are optical infrared emitters and detectors capable of projecting and receiving radiant energy beams transversely and longitudinally. The information from the sensors is transmitted via RF transmitters to the console 1 for use by the computer in calculating alignment parameters. The alignment display located in the console 1 indicates the necessary corrections to bring the subject vehicle's 14 alignment into conformity with vehicle manufacturer's specifications. Said specifications are preferably loaded into the computer prior to the commencement of the instant procedure. Adjustments are made as necessary to bring the vehicle into alignment according to vehicle manufacturer specifications. The alignment display located in the console 1 indicates when the vehicle alignment comes into accord with vehicle manufacturer specifications.

The method of the present invention may also be carried out with the use of leveling plates 7. Leveling plates 7 are recommended when the surface upon which the vehicle rests while alignment services are being performed is unstable and uneven. The leveling plates 7 may be secured in place through the use of plate securing stakes 8 and 9 which are driven through holes in the leveling plates 7 into the unstable surface for the purpose of holding the leveling plates 7 in place. The alignment measuring procedure is then carried out as indicated above, with the turn plates 12 and 13, and, if necessary, the shims 18 being placed upon the leveling plates 7. The procedure may also be carried out without the use of turn plates 12 and 13 wherein the subject vehicle 17 is driven directly onto the leveling plates 7 and alignment measurements are taken in accordance with the method described above.

It is also envisioned that the entire novel procedure may be performed on the subject vehicle 17 in the original location which it is found by the user of the novel portable alignment system. Since the novel system is truly mobile, the user may arrive at the vehicle owner's site and perform alignment services on the subject vehicle 17 in its existing location. This affords the owner the benefit of having the alignment services performed not only on-site, but also as other scheduled procedures and activities are being performed on the subject vehicle 17. In order to perform the novel procedure on the subject vehicle 17 in its existing location, the vehicle 17 is raised in its existing location to allow turn plates 12 and 13, leveling plates 7 and/or shims 18 to be placed below wheels 10 and 11 as needed.

Other embodiments of the present invention include: adding the step of leveling the turn plates 12 and 13 and/or the leveling plates 7 before driving the subject vehicle 17 onto said plates; hard wiring the electronic sensors 3, 4, 5, and 6 to the console 1 in order to transmit alignment data in areas where RF transmission is restricted or impractical, and; using other optical communication means allowing the electronic sensors 3, 4, 5, and 6 to communicate with one another using other than infrared radiation.

In view of the above it will be seen that the various objects and features of the invention are achieved and other advantageous results obtained. It should be understood that the description contained herein is illustrative only and is not to be taken in a limiting sense. Having thus described in detail certain preferred embodiments of the present invention, it is to be appreciated and will be apparent to those skilled in the art that many physical changes could be made in the apparatus and method without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

Although this invention has been described above with reference to particular means, materials and embodiments, it is to be understood that the invention is not limited to these disclosed particulars, but extends instead to all equivalents within the scope of the following claims.

I claim:

1. A portable wheel alignment system comprising:
a computer with manufacturer's alignment data loaded in it;
a monitor for displaying output of said computer;
electronic wheel sensors for mounting on four wheels of a first vehicle, each of said sensors having an emitter or detector adapted to communicate with said computer for evaluating wheel alignment of said first vehicle; and
an inclinometer adapted to account for the lack of level in an axle pitch or frame pitch of the first vehicle, wherein the computer and the monitor are mounted in a second vehicle for portability of said wheel alignment system.

2. The portable wheel alignment system of claim 1, which also comprises an optical level measurement means for the front axle of said first vehicle.

3. The portable wheel alignment system of claim 1, which includes shims for leveling the front axle of said first vehicle.

4. The portable wheel alignment system of claim 2, which includes shims for leveling the front axle of said first vehicle.
